(19) United States
(12) Patent Application Publication
(10) Pub. No.: US 2024/0097232 A1
(43) Pub. Date: Mar. 21, 2024

(54) BATTERY MANAGEMENT SYSTEM

(71) Applicant: TOYOTA JIDOSHA KABUSHIKI KAISHA, Toyota-shi Aichi-ken (JP)

(72) Inventor: Yoshiaki KIKUCHI, Toyota-shi Aichi-ken (JP)

(73) Assignee: TOYOTA JIDOSHA KABUSHIKI KAISHA, Toyota-shi Aichi-ken (JP)

(21) Appl. No.: 18/221,681

(22) Filed: Jul. 13, 2023

(30) Foreign Application Priority Data
Sep. 20, 2022 (JP) 2022-149361

(51) Int. Cl. H01M 10/63; H01M 10/0525; H01M 10/48; H01M 10/615

(52) U.S. Cl. CPC H01M 10/63; H01M 10/0525; H01M 10/486; H01M 10/615; H01M 2200/10

(57) ABSTRACT

The battery management system includes a plurality of battery units connected in parallel to each other, and a control device that executes temperature control for each battery of the plurality of battery units. The plurality of battery units includes a first battery unit having a LFP cell and a second battery unit having a ternary battery. When the temperature of the battery management system 1 is equal to or lower than the reference temperature, the control device executes the first temperature control so that the temperature of LFP cell is higher than the temperature of the ternary cell.

### CROSS-REFERENCE TO RELATED APPLICATION

This application claims priority to Japanese Patent Application No. 2022-149361 filed on Sep. 20, 2022 incorporated herein by reference in its entirety.

### BACKGROUND

### 1. Technical Field

The present disclosure relates to a battery management system.

### 2. Description of Related Art

Japanese Unexamined Patent Application Publication No. 2014-103804 (JP 2014-103804 A) discloses a battery system in which a plurality of assembled batteries is connected in parallel.

### SUMMARY

In the system as disclosed in JP 2014-103804 A, the types of the plurality of assembled batteries may be different from each other. Here, the internal resistances of the different types of assembled batteries may be different from each other. In this case, in particular, in the low-temperature range, the input/output characteristics vary for each assembled battery. Therefore, it is desired to suppress variations in input/output characteristics between different types of assembled batteries.

The present disclosure has been made in order to solve the above problem, and an object thereof is to suppress variations in input/output characteristics between different types of batteries.

A battery management system according to a first aspect of the present disclosure includes a battery management system for managing a battery. The battery management system includes: a plurality of battery units each including the battery and connected in parallel to each other; and a control device for executing temperature control on the battery of each of the battery units. The battery units include a first battery unit including an LFP battery, and a second battery unit including a ternary battery. When a temperature of the battery management system is equal to or lower than a reference temperature, the control device executes first temperature control such that a temperature of the LFP battery is higher than a temperature of the ternary battery.

In the battery management system according to the first aspect of the present disclosure, as described above, when the temperature of the battery management system is equal to or lower than the reference temperature, the first temperature control is executed such that the temperature of the LFP battery is higher than the temperature of the ternary battery. Here, the internal resistance of the LFP battery is larger than the internal resistance of the ternary battery. Therefore, in the low-temperature range, the input/output characteristics of the LFP battery are lower than the input/output characteristics of the ternary battery. Therefore, the input/output characteristics of the LFP battery can be improved by the first temperature control. As a result, even when the input/output characteristics of the LFP battery become lower than the input/output characteristics of the ternary battery due to the low-temperature of the battery management system, it is possible to suppress the input/output characteristics of the LFP battery from deviating from the input/output characteristics of the ternary battery. Consequently, it is possible to suppress variations in the input/output characteristics of the LFP battery and the ternary battery, whose types differ from each other.

In the battery management system according to the first aspect, the first temperature control includes control of making a charge and discharge power in the LFP battery larger than a charge and discharge power in the ternary battery. With such a configuration, the increase amount of the temperature of the LFP battery due to the charge and discharge power can be made higher than the increase amount of the temperature of the ternary battery due to the charge and discharge power.

In the battery management system according to the first aspect, the first temperature control includes control of making a temperature rise ripple current for the LFP battery larger than a temperature rise ripple current for the ternary battery. With such a configuration, the increase amount of the temperature of the LFP battery due to the temperature rise ripple current can be made higher than the increase amount of the temperature of the ternary battery due to the temperature rise ripple current.

In the battery management system according to the first aspect, the first battery unit further includes a heater for heating the LFP battery, and the first temperature control includes control of heating the LFP battery with the heater. With such a configuration, the temperature of the LFP battery can be easily increased by the heater.

In the battery management system according to the first aspect, the control device executes second temperature control for making a charge and discharge power in the ternary battery larger than a charge and discharge power in the LFP battery when the temperature of the battery management system is within a predetermined temperature range higher than the reference temperature, and executes third temperature control for making the charge and discharge power in the LFP battery and the charge and discharge power in the ternary battery equal to each other when the temperature of the battery management system is higher than the reference temperature and lower than a lower limit value of the predetermined temperature range. Here, when the temperature of the battery management system is relatively high, the influence of the magnitude of the amount of heat generated by the battery on the degree of deterioration of the battery becomes large. In addition, the amount of heat generated by a battery having a relatively high internal resistance tends to increase. Therefore, as described above, when the temperature of the battery management system is within the predetermined temperature range and is relatively high, the charge and discharge power of the ternary battery is made larger than the charge and discharge power of the LFP battery, so that it is possible to suppress the deviation between the amount of heat generated by the ternary battery and the amount of heat generated by the LFP battery. Consequently, it is possible to suppress the degree of deterioration of the ternary battery from deviating from the degree of deterioration of the LFP battery. Further, in the medium temperature range between the reference temperature and the predetermined temperature range, it is possible to suppress a difference from occurring between the charge and discharge power in the LFP battery and the charge and discharge power in the ternary battery.

According to the present disclosure, it is possible to suppress variations in input/output characteristics between batteries of different types.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a battery management system according to a first embodiment;

FIG. 2 is a diagram illustrating a relationship between a temperature and charge/discharge power of a battery according to the first embodiment;

FIG. 3 is a flow diagram illustrating a control flow of the control device according to the first embodiment;

FIG. 4 is a diagram illustrating a configuration of a battery management system according to a second embodiment;

FIG. 5 is a flow diagram illustrating a control flow of the control device according to the second embodiment;

FIG. 6 is a diagram illustrating a configuration of a battery management system according to a third embodiment; and

FIG. 7 is a flow diagram illustrating a control flow of the control device according to the third embodiment.

### DETAILED DESCRIPTION OF EMBODIMENTS

Hereinafter, an embodiment of the present disclosure will be described in detail with reference to the drawings. The same or corresponding parts in the drawings are designated by the same reference signs and repetitive description will be omitted.

### First Embodiment

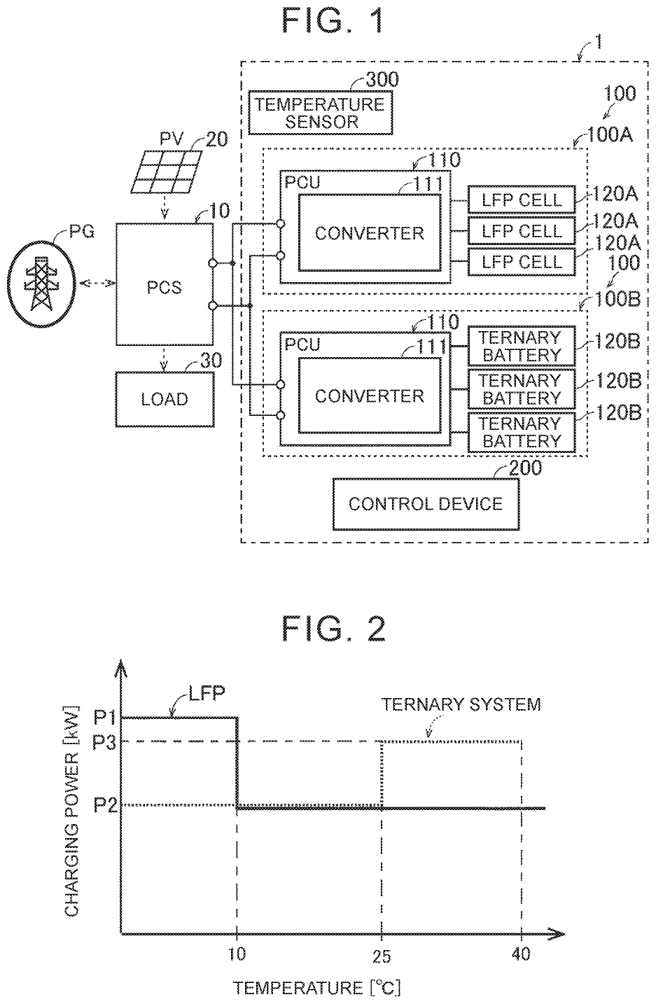

FIG. 1 is a diagram illustrating a configuration of a battery management system 1 according to a first embodiment. The battery management system 1 includes a plurality of battery units 100, a control device 200, and a temperature sensor 300.

The plurality of battery units 100 are connected in parallel to each other with respect to Power Conditioning System (PCS)10. A PCS 10 is a power converter capable of both AC/DC and DC/AC transformation. PCS 10 receives DC power from the photovoltaic device 20, for example. PCS 10 also supplies AC power to the loads 30. The load 30 includes electric appliances (for example, an air conditioner, a lighting fixture, and the like) used in the home. PCS 10 exchanges AC power with the power system PG.

The plurality of battery units 100 includes a first battery unit 100A and a second battery unit 100B. Although only one of the first battery unit 100A and the second battery unit 100B is shown in FIG. 1, a plurality of the first battery unit 100A and the second battery unit 100B may be provided.

The first battery unit 100A includes a converter 111 and a plurality of iron-phosphate-based lithium-ion batteries (hereinafter referred to as “LFP batteries”) 120A. The converters 111 are provided in Power Control Unit (PCU) 110. The converter 111 converts DC power between PCS 10 and the cell 120A. More specifically, the converters 111 boost the DC power from PCS 10. As a result, the plurality of LFP cell 120A is charged by the DC power from PCS 10. In addition, the converters 111 step down the DC power from the plurality of LFP cell 120A. As a result, the power of the plurality of LFP cell 120A is discharged to PCS 10. Note that the converter 111 may step up/down the DC power so that charge/discharge is performed between the first battery unit 100A and the second battery unit 100B.

The second battery unit 100B includes converters 111 and a plurality of ternary lithium-ion batteries (hereinafter referred to as “ternary batteries”) 120B. The operation of the converter 111 in the second battery unit 100B is similar to the operation of the converter 111 in the first battery unit 100A.

The internal resistance of LFP cell 120A is higher than the internal resistance of the ternary cell 120B. Each of LFP cell 120A and the ternary cell 120B is an exemplary “cell” disclosed herein.

The temperature sensor 300 measures the temperature of the battery management system 1. The temperature of the battery management system 1 may be the temperature of LFP cell 120A or the temperature of the ternary cell 120B. The control device 200 acquires information on the temperature measured by the temperature sensor 300.

The control device 200 includes a processor and a memory (neither of which is shown), and controls each of the plurality of battery units 100. For example, the control device 200 executes temperature control of a battery (120A, 120B) of each of the plurality of battery units 100.

Here, in a conventional system including different types of assembled batteries, the input/output characteristics (typically, the upper limit value of electric power/current that can be charged and discharged) vary for each of the assembled batteries due to the difference in internal resistance between the assembled batteries, particularly in the low-temperature range. It is desired to suppress variation in input/output characteristics between different types of assembled batteries.

Therefore, in the first embodiment, the control device 200 executes the first temperature control so that the temperature of LFP cell 120A becomes higher than the temperature of the ternary cell 120B when the temperature of the battery management system 1 is equal to or lower than the reference temperature (for example, when the temperature is within a low temperature range of 10° C. or lower). In the following, LFP cell 120A and the ternary cell 120B are charged with the first thermal control. However, the first temperature control (and the second temperature control and the third temperature control described later) may be executed at the time of discharging each battery.

As shown in FIG. 2, the first temperature control includes a control of making the charging power in LFP cell 120A larger than the charging power in the three-way cell 120B. Specifically, the control device 200 increases the charge power in LFP cell 120A based on the fact that the temperature measured by the temperature sensor 300 has decreased to 10° C. or less. On the other hand, the control device 200 does not change the charge power in the ternary battery 120B even when the temperature measured by the temperature sensor 300 decreases to 10° C. or less.

In the example illustrated in FIG. 2, the control device 200 fixes the charge power in LFP cell 120A to P1 when the temperature of the battery management system 1 is equal to or lower than the reference temperature. In addition, when the temperature of the battery management system 1 is equal to or lower than the reference temperature, the control device 200 fixes the charge power in the ternary battery 120B to a P2 smaller than P1.

In addition, when the temperature of the battery management system 1 is within a predetermined temperature range higher than the reference temperature (10° C.) (for example, in a high-temperature range of 25° C. to 40° C.), the control device 200 executes a second temperature control for increasing the charging power in the ternary battery 120B to be larger than the charging power in LFP battery 120A.

Specifically, the control device 200 increases the charge power in the ternary battery 120B based on the fact that the temperature measured by the temperature sensor 300 has increased to 25° C. (lower limit of the predetermined range) or more. On the other hand, the control device 200 does not change the charge power in LFP cell 120A even when the temperature measured by the temperature sensor 300 is increased to 25° C. or higher.

In the embodiment illustrated in FIG. 2, the control device 200 fixes the charge power in LFP cell 120A to P2 when the temperature of the battery management system 1 is within the predetermined temperature range. In addition, when the temperature of the battery management system 1 is within the predetermined temperature range, the control device 200 fixes the charge power in the ternary battery 120B to a P3 larger than P2. In FIG. 2, P1 is larger than P3, but P3 may be P1 or more.

In addition, when the temperature of the battery management system 1 is higher than the reference temperature and lower than the lower limit of the predetermined temperature range (that is, in the middle temperature range higher than 10° C. and lower than 25° C.), the control device 200 executes the third temperature control for making the charging power in LFP battery 120A and the charging power in the ternary battery 120B equal to each other.

Specifically, the control device 200 fixes the charge/discharge power in each of LFP cell 120A and the ternary cell 120B to P2 in the intermediate temperature range. Note that, in FIG. 2, the charge/discharge power of LFP cell 120A and the charge power of the ternary cell 120B in the intermediate temperature range are slightly shifted from each other so as to be easily understood.

Note that, in FIG. 2, an example is shown in which the charging power is fixed to a predetermined value in each temperature range, but the present disclosure is not limited thereto. In each temperature range, the charge/discharge power may change according to the temperature change of the battery management system 1.

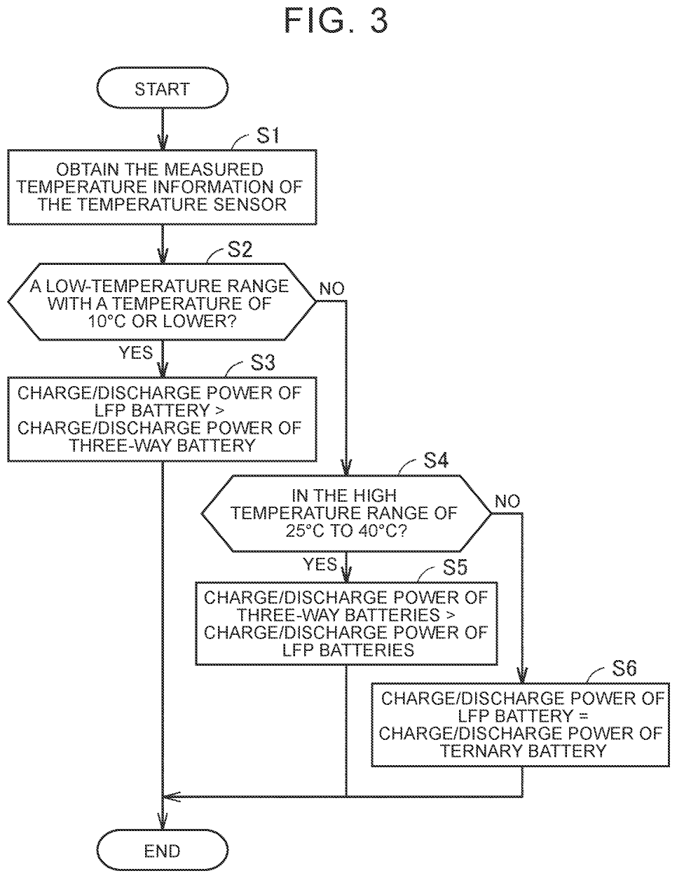

Control flow of the control device Next, a control flow of the control device 200 will be described with reference to FIG. 3. The processing flow illustrated in FIG. 3 may be repeatedly executed every predetermined time (for example, one hour). In S1, the control device 200 acquires the temperature measured by the temperature sensor 300 (the temperature of the battery management system 1).

In S2, the control device 200 determines whether or not the temperature of the battery management system 1 is 10° C. or less (in the low-temperature range) based on the temperature information acquired in S1. When the temperature is 10° C. or lower (Yes in S2), the process proceeds to S3. If the temperature is higher than 10° C. (No in S2), the process proceeds to S4.

In S3, the control device 200 executes the above-described first temperature control that makes the charge/discharge power of LFP cell 120A larger than the charge/discharge power of the ternary cell 120B.

In S4, the control device 200 determines whether the temperature of the battery management system 1 is within the range of 25° C. to 40° C. (within the high-temperature range) based on the temperature information acquired in S1. If the temperature is within the above range (Yes in S4), the process proceeds to S5. If the temperature is outside the above range and within the range of 10° C. to 25° C. (No in S4), the process proceeds to S6.

In S5, the control device 200 executes the above-described second temperature adjustment control for making the charge/discharge power of the three-way battery 120B larger than the charge/discharge power of LFP battery 120A.

In S6, the control device 200 executes the third temperature control for equalizing the charge/discharge power of LFP cell 120A and the charge/discharge power of the ternary cell 120B.

As described above, in the first embodiment, when the temperature of the battery management system 1 is equal to or lower than the reference temperature, the control device 200 executes the first temperature control so that the temperature of LFP cell 120A is higher than the temperature of the ternary battery 120B. Accordingly, the input/output performance of LFP cell 120A can be suppressed from becoming smaller due to a decrease in the temperature of the battery management system 1. Consequently, the input/output characteristics of LFP cell 120A and the input/output characteristics of the ternary cell 120B can be easily made uniform.

### Second Embodiment

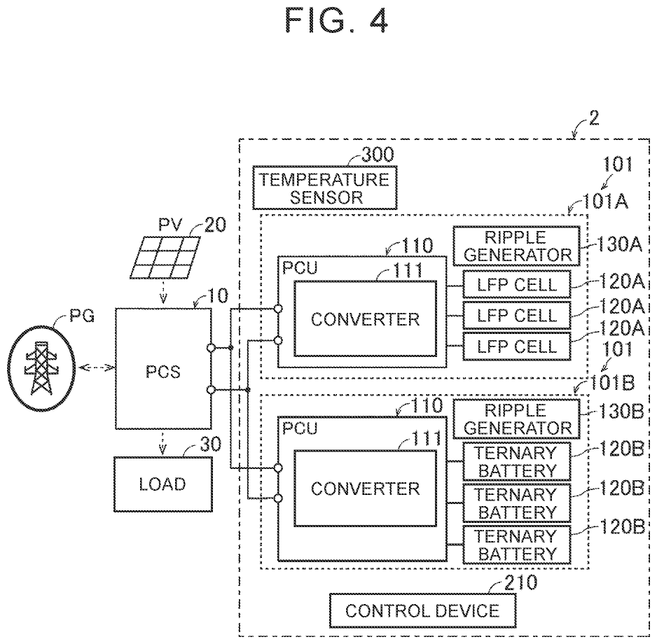

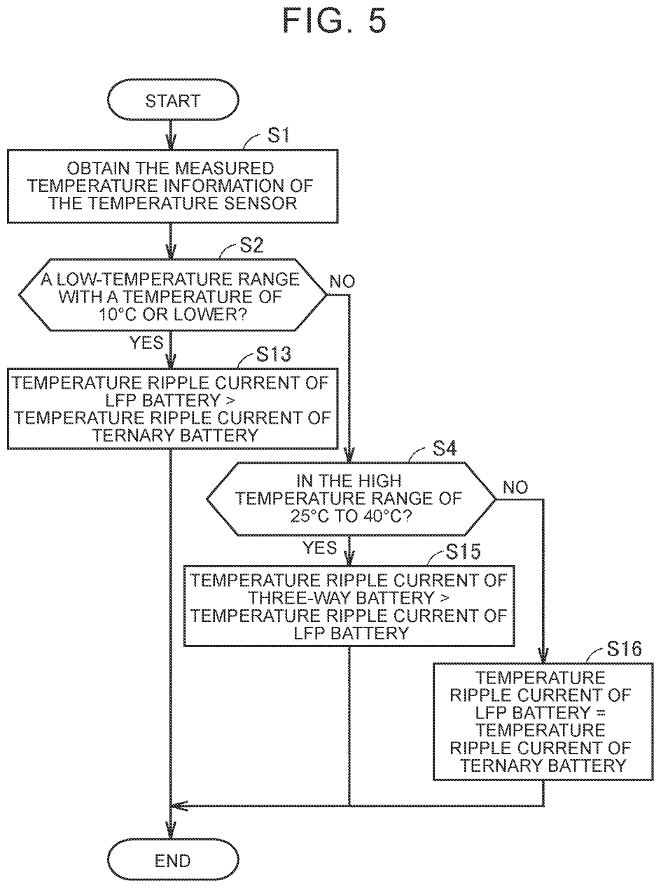

Next, a second embodiment of the present disclosure will be described with reference to FIGS. 4 and 5. In the second embodiment, unlike the above-described first embodiment in which the charge and discharge power of the battery is controlled, the temperature rise ripple current is controlled. The same components as those in the first embodiment are denoted by the same reference numerals and will not be described repeatedly.

As illustrated in FIG. 4, the battery management system 2 includes a plurality of battery units 101, a control device 210, and a temperature sensor 300.

The plurality of battery units 101 includes a first battery unit 101A and a second battery unit 101B. The first battery unit 101A further includes a ripple generation unit 130A in addition to the configuration of the first battery unit 100A (see FIG. 1) of the first embodiment. The second battery unit 101B further includes a ripple generation unit 130B in addition to the configuration of the second battery unit 100B (see FIG. 1) of the first embodiment.

The ripple generator 130A is connected to LFP cell 120A. The ripple generator 130A generates a temperature-rising ripple current having a predetermined frequency, a predetermined duty, and a predetermined magnitude in LFP cell 120A. The ripple generator 130B is connected to the ternary cell 120B. The ripple generator 130B generates a temperature-rising ripple current having a predetermined frequency, a predetermined duty, and a predetermined magnitude in the ternary cell 120B. Each of the frequency and the amplitude of the temperature-raising ripple current is controlled by the control device 200.

In the second embodiment, when the temperature of the battery management system 2 is equal to or lower than the reference temperature, the control device 210 makes the temperature rise ripple current for LFP cell 120A larger than the temperature rise ripple current for the ternary cell 120B. As a result, the first temperature control is performed in which the temperature of LFP cell 120A is higher than the temperature of the ternary cell 120B.

### Control Flow of the Control Device

Next, a control flow of the control device 210 will be described with reference to FIG. 5. The processing flow illustrated in FIG. 5 may be repeatedly executed every predetermined time (for example, one hour). The same processing as in the first embodiment is denoted by the same reference numerals and will not be described repeatedly.

If Yes in S2, S13 is processed. In S13, the control device 210 executes the first temperature control so that the temperature rise ripple current of LFP cell 120A becomes larger than the temperature rise ripple current of the ternary cell 120B. Specifically, the control device 210 controls the ripple generation unit 130A and the ripple generation unit 130B to control the temperature rise ripple current of LFP cell 120A and the temperature rise ripple current of the ternary cell 120B. For example, the control device 210 makes the amplitude of the temperature-rising ripple current of LFP cell 120A larger than the amplitude of the temperature-rising ripple current of the ternary cell 120B. The control device 210 may set the duty of the temperature-raising ripple current of LFP cell 120A to be larger than the duty of the temperature-raising ripple current of the ternary cell 120B. The frequency of the temperature-raising ripple current of each of LFP cell 120A and the ternary cell 120B may be controlled. At this time, the temperature-raising ripple current of the three-way battery 120B does not have to be generated.

If Yes in S4, S15 is processed. In S15, the control device 210 executes the second temperature control so that the temperature rise ripple current of the ternary battery 120B becomes larger than the temperature rise ripple current of LFP battery 120A. For example, the control device 210 controls the ripple generation unit 130A and the ripple generation unit 130B to make the amplitude and/or the duty of the temperature-rising ripple current of the ternary battery 120B larger than the amplitude and/or the duty of the temperature-rising ripple current of LFP battery 120A. At this time, the temperature rise ripple current of LFP cell 120A does not have to be generated.

If No in S4, S16 is processed. In S16, the control device 210 executes the third temperature control so that the temperature rise ripple current of LFP cell 120A and the temperature rise ripple current of the ternary cell 120B are equal to each other. For example, the control device 210 controls the ripple generation unit 130A and the ripple generation unit 130B to make the amplitude and the duty of the temperature-rising ripple current of LFP cell 120A equal to the amplitude and the duty of the temperature-rising ripple current of the ternary cell 120B. At this time, it is not necessary to generate the temperature-rising ripple current of LFP cell 120A and the temperature-rising ripple current of the ternary cell 120B.

### Third Embodiment

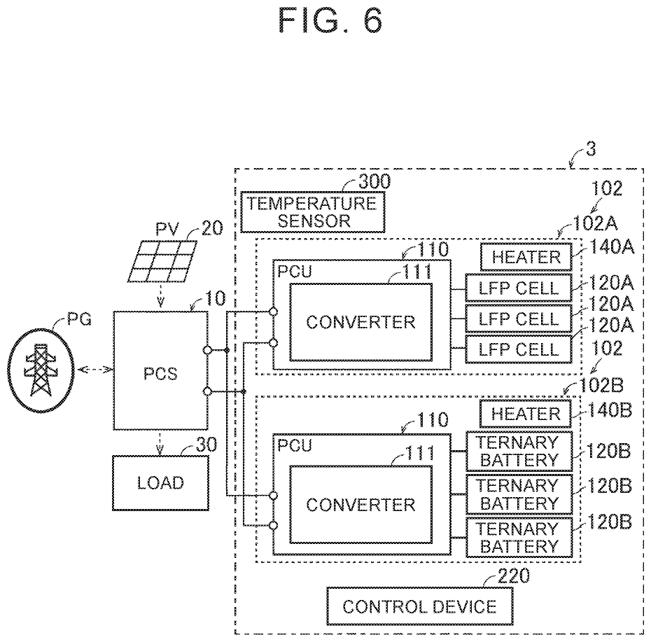

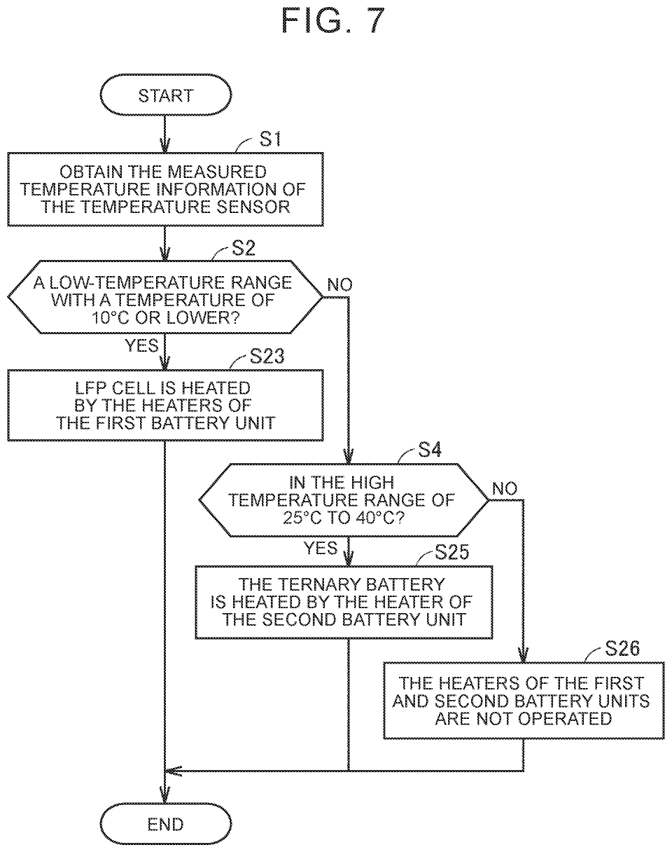

Next, a third embodiment of the present disclosure will be described with reference to FIGS. 6 and 7. In the third embodiment, unlike the first embodiment, in which the temperature of the battery is controlled by controlling the charge and discharge power of the battery, the temperature of the battery is controlled by controlling the heater. The same components as those in the first embodiment are denoted by the same reference numerals and will not be described repeatedly.

As illustrated in FIG. 6, the battery management system 3 includes a plurality of battery units 102, a control device 220, and a temperature sensor 300.

The plurality of battery units 102 includes a first battery unit 102A and a second battery unit 102B. The first battery unit 102A further includes a heater 140A in addition to the configuration of the first battery unit 100A (see FIG. 1) of the first embodiment. The second battery unit 102B further includes a heater 140B in addition to the configuration of the second battery unit 100B (see FIG. 1) of the first embodiment.

The heater 140A heats LFP cell 120A. The heater 140B heats the ternary cell 120B.

In the third embodiment, when the temperature of the battery management system 3 is equal to or lower than the reference temperature, the control device 220 controls LFP cell 120A to be heated by the heater 140A. As a result, the first temperature control is performed in which the temperature of LFP cell 120A is higher than the temperature of the ternary cell 120B.

### Control Flow of the Control Device

Next, a control flow of the control device 220 will be described with reference to FIG. 7. The processing flow illustrated in FIG. 7 may be repeatedly executed every predetermined time (for example, one hour). The same processing as in the first embodiment is denoted by the same reference numerals and will not be described repeatedly.

If Yes in S2, S23 is processed. In S23, the control device 220 executes the first temperature control for heating LFP cell 120A by the heater 140A of the first battery unit 102A. At this time, the heater 140B of the second battery unit 102B may or may not be operated with low power. Accordingly, the temperature of LFP cell 120A is higher than the temperature of the ternary cell 120B.

If Yes in S4, S25 is processed. In S25, the control device 220 executes the second temperature control for heating the ternary battery 120B by the heater 140B of the second battery unit 102B. At this time, the heater 140A of the first battery unit 102A may or may not be operated with low power. Thus, the temperature of the ternary cell 120B is higher than the temperature of LFP cell 120A.

If No in S4, S26 is processed. In S26, the control device 220 executes a third temperature control for deactivating each of the heater 140A and the heater 140B.

In the second embodiment, the ripple generation unit (130A, 130B) is provided in each of the first battery unit 101A and the second battery unit 101B. For example, the ripple generation unit 130B may not be provided in the second battery unit 101B.

In the third embodiment, heaters (140A, 140B) are provided in each of the first battery unit 102A and the second battery unit 102B. For example, the second battery unit 102B may not be provided with the heater 140B.

In each of the first battery unit 102A and the second battery unit 102B, a cooler may be provided instead of the heaters. For example, in the low-temperature range, the ternary cell 120B may be cooled by a cooler. In the high temperature range, LFP cell 120A may be cooled by a cooler.

The controls of the first through third embodiments may be combined with each other. For example, the first temperature control may include control of the charge/discharge power, and the second temperature control may include control of the temperature rise ripple current.

In the first to third embodiments described above, the battery management system (1, 2, 3) is provided with the temperature sensor 300, but the present disclosure is not limited thereto. For example, the control device may acquire the temperature measured by a temperature sensor (air temperature sensor) outside the battery management system as the temperature of the battery management system by communication or the like.

The embodiment disclosed herein should be considered as illustrative and not restrictive in all respects. The scope of the present disclosure is shown by the claims, rather than the above embodiment, and is intended to include all modifications within the meaning and the scope equivalent to those of the claims.

What is claimed is:

1. A battery management system for managing a battery, the battery management system comprising:
a plurality of battery units each including the battery and connected in parallel to each other; and
a control device for executing temperature control on the battery of each of the battery units, wherein
the battery units include a first battery unit including an LFP battery, and a second battery unit including a ternary battery, and
when a temperature of the battery management system is equal to or lower than a reference temperature, the control device executes first temperature control such that a temperature of the LFP battery is higher than a temperature of the ternary battery.

2. The battery management system according to claim 1, wherein the first temperature control includes control of making a charge and discharge power in the LFP battery larger than a charge and discharge power in the ternary battery.

3. The battery management system according to claim 1, wherein the first temperature control includes control of making a temperature rise ripple current for the LFP battery larger than a temperature rise ripple current for the ternary battery.

4. The battery management system according to claim 1, wherein
the first battery unit further includes a heater for heating the LFP battery, and
the first temperature control includes control of heating the LFP battery with the heater.

5. The battery management system according to claim 1, wherein the control device
executes second temperature control for making a charge and discharge power in the ternary battery larger than a charge and discharge power in the LFP battery when the temperature of the battery management system is within a predetermined temperature range higher than the reference temperature, and
executes third temperature control for making the charge and discharge power in the LFP battery and the charge and discharge power in the ternary battery equal to each other when the temperature of the battery management system is higher than the reference temperature and lower than a lower limit value of the predetermined temperature range.
